(19) United States
(12) Patent Application Publication
(10) Pub. No.: US 2004/0128336 A1
(43) Pub. Date: Jul. 1, 2004

(54) Method and system for multiplication of binary numbers

(76) Inventor: Clemens M. Zierhofer, Kundl (AT)

Correspondence Address: BROMBERG & SUNSTEIN LLP, 125 SUMMER STREET, BOSTON, MA, 02110-1618, US

(21) Appl. No.: 10/682,814

(22) Filed: Oct. 9, 2003

Related U.S. Application Data
(63) Continuation-in-part of application No. 10/646,463, filed on Aug. 22, 2003, now abandoned.
(60) Provisional application No. 60/405,241, filed on Aug. 22, 2002.

(51) Int. Cl. G06F 7/52

(52) U.S. Cl. 708/625

(57) ABSTRACT

A multiplier for multiplying a first signal representing a first binary number A=[a_{N-1} . . . a₁ a₀] and a second signal representing a second binary number B=[b_{N-1} . . . b₁ b₀]. The multiplier includes a first port for receiving the first signal, and a second port for receiving the second signal. A first circuit generates a triangle array as a function of the first signal and the second signal. An adder may add elements of the triangle array to produce a third signal representing a product of the first signal and the second signal.

### CROSS REFERENCE TO RELATED APPLICATIONS

This application is a continuation-in-part of U.S. patent application No. 10/646,463, filed on Aug. 22, 2003, entitled “Method and System for Multiplication of Binary Numbers”, which claim priority from U.S. provisional application serial No. 60/405,241, filed Aug. 22, 2002, entitled “Method and System for Multiplication of Binary Numbers”. Each of the above-mentioned applications is hereby incorporated herein by reference.

### TECHNICAL FIELD

The present invention relates to an efficient method and system for multiplying binary numbers.

### BACKGROUND ART

Two N-bit binary numbers A=[a_{N-1} a_{N-2} . . . a₁ a₀] and B=[b_{N-1} b_{N-2} . . . b₁ b₀] are commonly multiplied as shown in FIG. 1 (prior art). Here, the multiplication of two 8-bit numbers A=185_{dec}=[1 0 1 1 1 0 0 1] and B=237_{dec}=[1 1 1 0 1 1 0 1] to form a product 104 is depicted.

The product A*B is the sum of single partial products at particular binary positions. The single partial products are either number B or zero, dependent on the associated bit within number A. For example, the LSB of A, a₀=1, and thus the partial product at binary position 2⁰ is number B=[1 1 1 0 1 1 0 1]. The neighboring bit a₁=0, and thus the associated partial product is [0 0 0 0 0 0 0 0]. As used in this description and the accompanying claims, the array of partial products 102 formed by this common method of multiplication shall be referred to as a “diamond-array”. The diamond-array 102 depicted in FIG. 1 requires that 64 digits be added to form the product.

FIG. 2 (prior art) shows multiplication using a well-known Booth scheme. Multiplication using the Booth methodology reduces the number of partial products in a diamond-array by a factor of about 2. This is accomplished by representing one of the multiplicands by numbers whose binary weights differ by at least a factor 4. However, the Booth scheme disadvantageously requires that negative numbers be introduced. For example, number A=185_{dec}=[1 0 1 1 1 0 0 1] is commonly regarded as a sum of positive terms: 2⁷+2⁵+2⁴+2³+2₀. Following the Booth scheme, the number A is instead represented as 2₈−2⁶−2*2²+2⁰. Thus, the negative partial sums have to be represented as twos compliment numbers.

Note that at least every second binary position of A is necessarily zero. However, the representation of negative numbers by twos compliment requires leading sequences of ones, which significantly reduce the benefit of the approximately 50% reduction in the number of partial products 201. For N=8, 60 digits remain to be added using the Booth methodology.

### SUMMARY

In accordance with one aspect of the invention, a multiplier for multiplying a first binary number A=[a_{N-1} . . . a₁ a₀] and a second binary number B=[b_{N-1} . . . b₁ b₀] is presented. The multiplier includes a first port for receiving a first signal representing the binary number A, and a second port for receiving a second signal representing the binary number B. A first circuit generates a triangle array as a function of the first signal and the second signal.

In accordance with related embodiments of the invention, an adder may add elements of the triangle array to form a third signal representing a product of the first signal and the second signal. A second circuit may position the elements of the triangle array to form a reduced array having a reduced number of lines compared to the triangle array. The second circuit may be operatively coupled to the adder such that the adder adds the reduced number of lines when adding elements of the triangle array. The reduced array may have

$$\frac{N}{2} + 1$$

lines for even N, and

$$\frac{N + 1}{2}$$

lines for odd N.

In accordance with another aspect of the invention, a processor for multiplying a first binary number A=[a_{N-1} . . . a₁ a₀] and a second binary number B=[b_{N-1} . . . b₁ b₀] is presented. The processor includes input means for receiving a first signal and a second signal. The first signal represents the first binary number A, and the second signal represents the second binary number B. The processor also includes means for forming a triangle array as a function of the first signal and the second signal.

In accordance with related embodiments of the invention, an adder may add elements of the triangle array to form a third signal representing a product of the first signal and the second signal. A positioning circuit may position the elements of the triangle array to form a reduced array having a reduced number of lines compared to the triangle array. The repositioning circuit may be operatively coupled to the adder such that the adder adds the reduced number of lines when adding elements of the triangle array. The reduced array may have

$$\frac{N}{2} + 1$$

lines for even N, and

$$\frac{N + 1}{2}$$

lines for odd N.

In accordance with still another aspect of the invention, a method for performing digital signal processing that requires multiplication of a first signal representing a binary number A=[a_{N-1} . . . a₁ a₀] and a second signal representing a second binary number B=[b_{N-1} . . . b₁ b₀] is presented. The method includes receiving the first and second signal. A triangle array is formed as a function of the first signal and the second signal.

In accordance with related embodiments of the invention, elements of the triangle array may be added to form a third signal representing a product of the first signal and the second signal. Elements of the triangle array may be positioned to form a reduced array having a reduced number of lines compared to the triangle array, wherein adding elements of the triangle array includes adding the reduced number of lines.

In accordance with yet another aspect of the invention, a computer program product for use on a computer system for multiplying a first binary number A=[a_{N-1} . . . a₁ a₀] and a second binary number B=[b_{N-1} . . . b₁ b₀] is presented. The computer program product includes a computer usable medium having computer readable program code thereon. The computer readable program code includes program code for forming a triangle array as a function of the first binary number and the second binary number.

In accordance with related embodiments of the invention, the computer readable program code may include program code for adding elements of the triangle array to produce a third number representing a product of the first binary number and the second binary number. The computer readable program code may include program code for positioning the elements of the triangle array to form a reduced array having a reduced number of lines compared to the triangle array, wherein the program code for adding elements of the triangle array adds the reduced number of lines. The reduced array may have

$$\frac{N}{2} + 1$$

lines for even N, and

$$\frac{N + 1}{2}$$

lines for odd N.

In accordance with embodiments related to the above-described embodiments of the invention, the triangle array includes lines k=0 to N−1, such that line k=0 of the triangle array is equal to [0 a₀*b₀]. For lines k=1 to N−1, the lines of the triangle array are determined by: [0ₖ₊₁ 0ₖ 0ₖ₋₁ . . . 0₀], if [aₖ bₖ]=[0 0]; [0ₖ₊₁ 0ₖ aₖ₋₁ . . . a₁ a₀], if [aₖ bₖ]=[0 1]; [0ₖ₊₁ 0ₖ bₖ₋₁ . . . b₁ b₀], if [aₖ bₖ]=[1 0]; and [cₖ not(cₖ) sₖ₋₁ . . . s₁ s₀], if [aₖ bₖ]=[1 1]. The sequence [s_{N-2} . . . s₁ s₀] is derived by binary adding numbers A′=[a_{N-2} . . . a₁ a₀] and B′=[b_{N-2} . . . b₁ b₀], whereby A′ and B′ are truncated versions of numbers A and B (i.e., without most significant bit). Sequence [c_{N-1} . . . c₁] is equal to the carry sequence associated with the sum sequence [s_{N-2} . . . s₁ s₀]. The triangle array thus formed may be represented by a number of digits that is approximately 20-50% less than the number of digits required in a diamond array. The triangle array may include N(N+3)/2 digits.

### BRIEF DESCRIPTION OF THE DRAWINGS

The foregoing features of the invention will be more readily understood by reference to the following detailed description, taken with reference to the accompanying drawings, in which:

FIG. 1 depicts prior art multiplication of two N-bit binary numbers A and B;

FIG. 2 depicts prior art multiplication of the binary numbers A and B employing Booth's algorithm;

FIG. 3 depicts diamond arrays with rotated V's, in accordance with one embodiment of the invention;

FIG. 4 is a table that shows possible peak-bit and branch configurations of a V, in accordance with one embodiment of the invention;

FIG. 5 depicts the addition of two branch numbers without the most significant bit, resulting in a sum sequence and a carry sequence, in accordance with one embodiment of the invention;

FIG. 6 depicts lower branch values when multiplying the numbers A and B, in accordance with one embodiment of the invention;

FIG. 7 depicts a resulting multiplication scheme prior to removal of zero bits positioned above pairs of peak-bits, in accordance with one embodiment of the invention;

FIG. 8 depicts a resulting multiplication scheme with zero bits positioned above the pairs of peak-bits removed, in accordance with one embodiment of the invention;

FIG. 9 is a table depicting the switching of bit sequences based on bits aₖ and bₖ, in accordance with one embodiment of the invention;

FIG. 10 depicts an example of an reduced array composed of only 5 lines, in accordance with one embodiment of the invention;

FIG. 11 depicts an example of an reduced array with only 5 lines of almost equal length, in accordance with one embodiment of the invention;

FIG. 12 is a block diagram of a multiplier for multiplying a first binary number and a second binary number, in accordance with one embodiment of the invention;

FIG. 13 is a schematic showing a circuit implementation of the block representing the “triangle array” in FIG. 12, in accordance with one embodiment of the invention; and

FIG. 14 is a schematic of a circuit implementation that can be used to form line 3 of the reduced array shown in FIG. 11, in accordance with one embodiment of the invention.

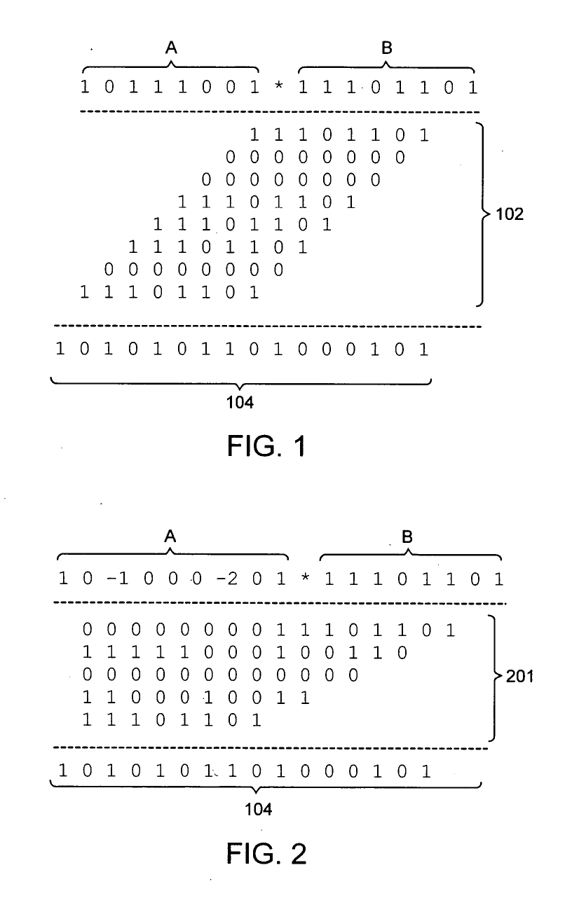

### DESCRIPTION

A method and system for efficiently multiplying binary numbers is presented. In particular, the method and system includes reducing the number of digits used in connection with partial products formed during multiplication. Details of various embodiments are discussed below.

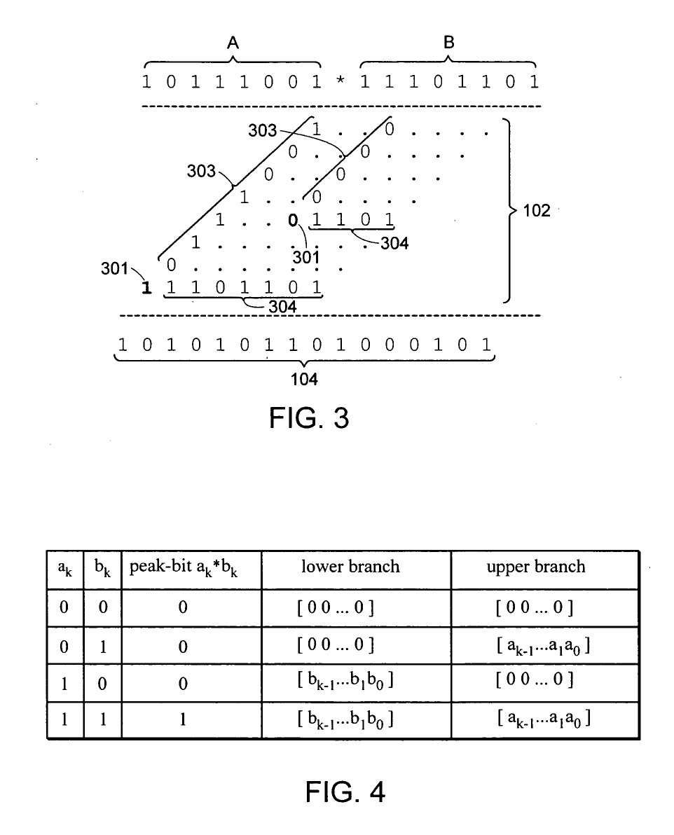

FIG. 3 shows an advantageous way of looking at the diamond-array 102 of FIG. 1, in accordance with one embodiment of the invention. Instead of looking at the lines of the array, the array can be regarded as composed of structures similar to “rotated V's”, whose peaks are looking to the left-lower corner. The V's have the following general properties:

(1) Each V has one peak-bit 301 and two branches 303 and 304 with an equal number of bits, respectively. The number of bits within a branch can also be zero. For example, a V may consist of only the peak-bit.

(2) The peak-bit 301 of each V is the product of the bits of equal binary position within numbers A and B, respectively. In FIG. 3, two V's 301 are highlighted. The corresponding peak-bits (bold) 301 are the products of the first bits (MSB) a₇*b₇=1 (as used in this description and the accompanying claims, “*” shall mean multiplication, unless the context requires otherwise), and bits a₃*b₃=0, respectively (see FIG. 4, discussed below).

(3) The branches 303 and 304 include either truncated versions of numbers A or B, or zeros only. In FIG. 3, the V 301 with peak-bit “1” has an upper branch containing 7 bits of A (i.e., [a₆ . . . a₁ a₀]=[0 1 1 1 0 0 1]), and a lower branch consisting of 7 bits of B (i.e., [b₆ . . . b₁ b₀]=[1 1 0 1 1 0 1]). The V 301 with peak bit “0” shows an upper branch 303 composed of 4 zeros (i.e., [0 0 0 0]) and a lower branch 304 composed of 4 bits of B (i.e., [b₃ b₂ b₁ b₀]=[1 1 0 1]).

(4) Four possible configurations can occur, determined by the two bits within A and B, that can be used to determine the peak-bit. FIG. 4 is a table that shows these four configurations, in accordance with one embodiment of the invention.

(5) The overall diamond-array is fully covered by exactly N non-overlapping V's.

The V's are defined by bits aₖ and bₖ at binary position k in numbers A and B, as summarized in FIG. 4. If both bits aₖ and bₖ are zero, both branches contain only zeros. For aₖ=0 and bₖ=1, bit sequence [aₖ₋₁ . . . a₁ a₀] appears in the upper branch, and for aₖ=1 and bₖ=0, sequence [bₖ₋₁ . . . b₁ b₀] appears in the lower branch. For aₖ=1 and bₖ=1, both sequences [aₖ₋₁ . . . a₁ a₀] and [bₖ₋₁ . . . b₁ b₀] have to be considered. In general, bits aₖ and bₖ can be regarded as switches, where bits aₖ activate or deactivate the truncated versions of number B, and bits bₖ activate or deactivate the truncated versions of number A.

Using the commutative law, upper and lower branches of the V's can be flipped arbitrarily, without changing the overall sum. For example, all zero-branches can be flipped such that they become upper branches. This causes a concentration of zeros in the upper left area of the diamond-array, that is, the region above the line of peak-bit elements. Only branches of V's whose peak-bit is “1” may contain non-zero elements in this region. These branches can be removed by means of the following steps:

(1) Addition of the upper and lower branches,

(2) Correction of the binary positions of the peak-bits (if necessary),

(3) Positioning of the results of (1) and (2) in the lower branches, and

(4) Set upper branches to zero.

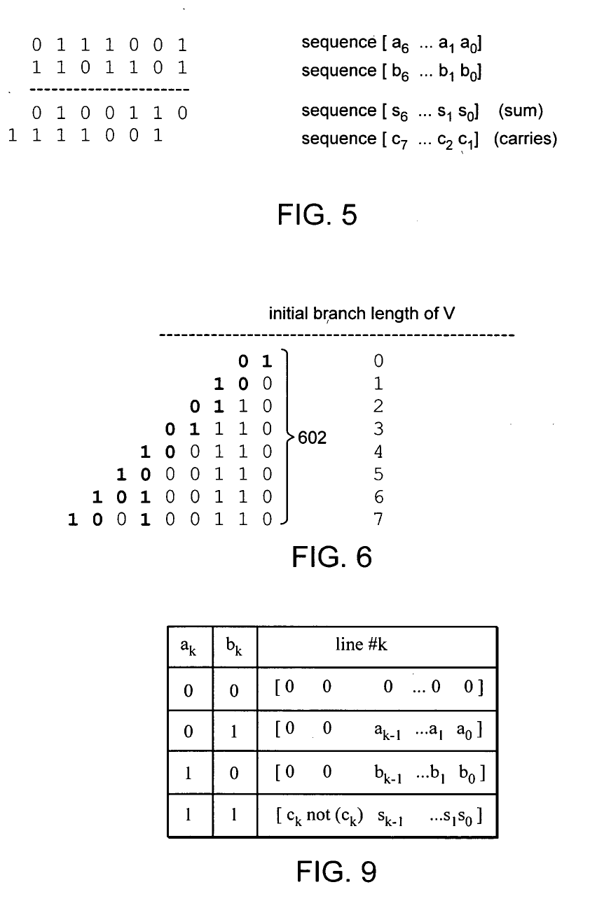

Fortunately, the addition (1) does not need to be done individually for each V of particular length. Instead, it can be done once by adding numbers A and B without the most significant bit, i.e., sequences A′=[a_{N-2} . . . a₁ a₀] and B′=[b_{N-2} . . . b₁ b₀ ]. This results in the sum-sequence [s_{N-2} . . . s₁ s₀], and the carry-sequence [c_{N-1} . . . c₂ c₁]. The carry-sequence is used for step (2). The binary position of bit cₖ within [c_{N-1} . . . c₂ c₁] is equal to the binary position of the associated peak-bit. The case cₖ=1 means that the peak-bit has to be shifted by one position to the left (according to the binary addition “1”+“1”=“10”). For the present example, these sum-sequence and carry-sequences are shown in FIG. 5. The resulting “lower branches” 602 are summarized for all branch-lengths in FIG. 6, in accordance with one embodiment of the invention. Shifting peak-bits by one position to the left is necessary in lines 1, 4, 5, 6, and 7 as indicated by the carry-sequence in FIG. 5.

After flipping branches of V's with peak-bit “0” as described above, and representing V's with peak-bit “1” as lower branches 602 according to FIG. 6, the multiplication scheme looks like FIG. 7, in accordance with one embodiment of the invention. Note that the single peak-bits are replaced by pairs of bits (bold), which represent the digits at the positions of the peak-bits together with their left neighbors, respectively.

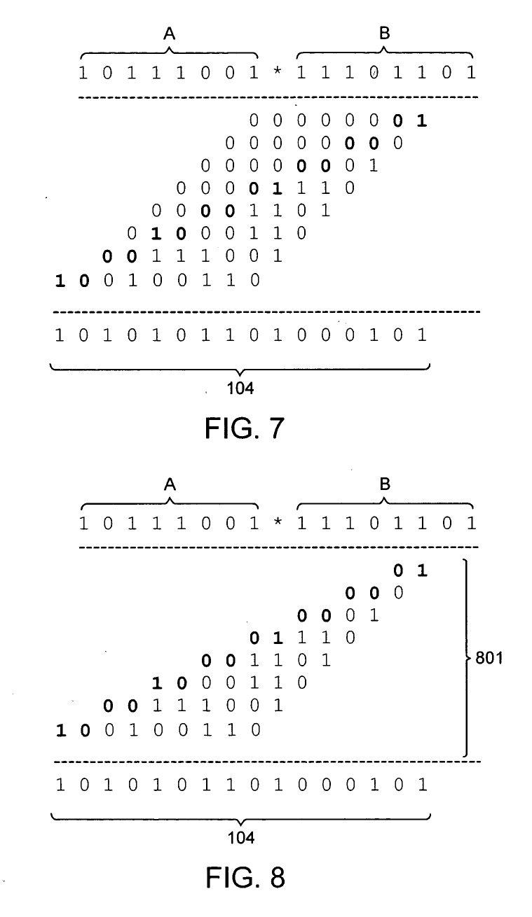

Now all bits above the bold pairs depicted in bold are zero and thus can be omitted as shown in FIG. 8, in accordance with one embodiment of the invention. As used in this description and the accompanying claims, the resulting array shall generally be referred to as a “triangle-array.” The general rules defining the lines of a triangle-array for multiplication of two N-bit numbers are summarized in FIG. 9. Depending on bits aₖ and bₖ, basically four different types of lines can occur. Line number k (with [0≦k≦N−1]) in general is composed of k+2 bits. The trailing k bits are zeros, or truncated versions of either number A, or number B, or the sum-sequence A+B. The two leading bits are either zeros or digits cₖ and not(cₖ) (i.e., the compliment of cₖ). For the special case k=0, the two elements of the line are 0 and a₀*b₀. The absolute binary weight of line number k in the triangle-array is 2^{k}. In a practical implementation, the type of line can be selected using a multiplexer for each line, which may be a 4-to-1 multiplexer. The inputs into the multiplexer can be [0ₖ₊₁ 0ₖ 0ₖ₋₁ . . . 0₀ ], [0ₖ₊₁ 0ₖ aₖ₋₁ . . . a₁ a₀], [0ₖ₊₁ 0ₖ bₖ₋₁ . . . b₁ b₀], or [cₖ not(cₖ) s^{k-1} . . . s₁ s₀], which are controlled by aₖ and bₖ.

As compared to the scheme depicted in FIG. 1, the diamond-array 102 with exactly 64 digits has changed to the triangle-array 801 with exactly 44 digits, a bit-reduction of approximately 30%. This reduction also compares favorably to the Booth-algorithm, which requires 60 digits to be added for N=8, considerably more than the 44 digits required for N=8 in the present invention.

For arbitrary N (even or odd), diamond arrays are composed of N² digits, whereas triangle-arrays consist of exactly

$$\frac{N ( N + 3 )}{2}$$

digits. Thus for larger N, a bit-reduction of roughly 50% may be achieved.

In accordance with various embodiments of the invention, vertical shifting of the columns of the triangle-arrays can be accomplished in order to reduce the number of lines. This modifies the shape of the triangle-array without changing the multiplication result. As used in this description and the accompanying claims, arrays derived from triangle-arrays by vertical shifting of columns generally will be referred to as “reduced-arrays”.

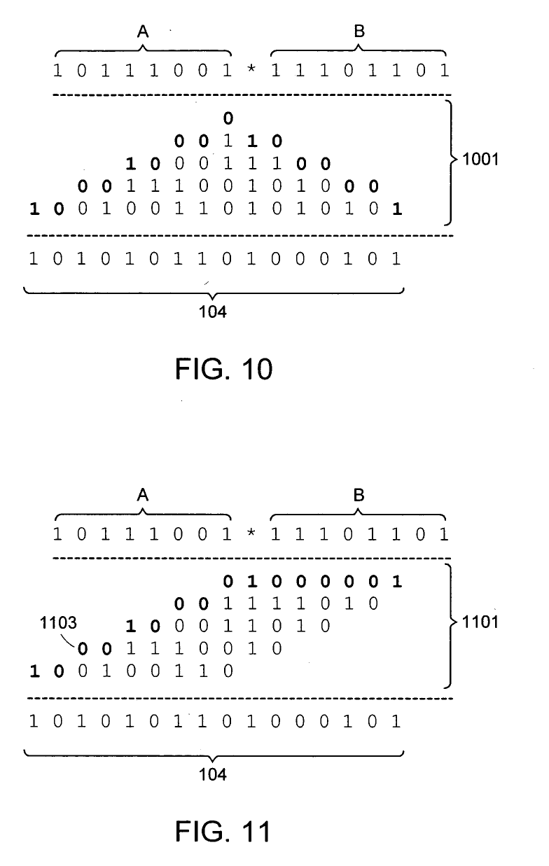

Examples of reduced-arrays that originate from the triangle-array of FIG. 8 are shown in FIGS. 10 and 11. In FIG. 10, the columns of the right half of the triangle array (columns 10-16) are shifted downwards such that a reduced array 1001 with triangle-shape with only 5 lines is obtained. The number of digits in each line of the reduced-array 1001 is not constant and varies from 1 digit (top line) to 16 digits (bottom line).

In FIG. 11, down-shifting of the columns of the right half of the triangle-array (columns 11-16) yields a reduced-array 1101 with diamond shape. As above, it is composed of 5 lines, but here the lines show almost equal length. All lines contain 9 digits, except for the top line with only 8 digits.

Thus, in general, reduced-arrays with a minimum number of lines can be obtained by vertically shifting columns of triangle-arrays. The minimum number of lines is given by

$$\frac{N}{2} + 1$$

for even N, and

$$\frac{N + 1}{2}$$

for odd N. Reducing the number of lines can advantageously reduce the number of clock cycles required when lines are added in a sequential manner.

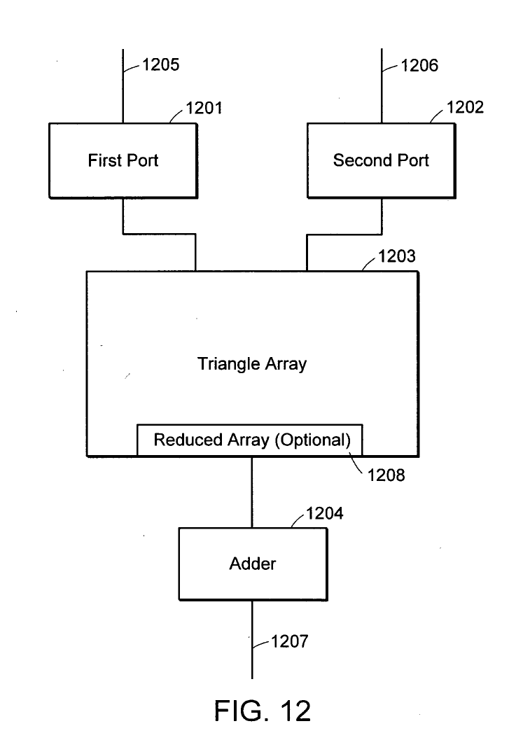

FIG. 12 shows a block diagram of a multiplier 1200 for multiplying a first signal 1205 and a second signal 1206, in accordance with one embodiment of the invention. The first signal 1205 represents a first binary number A=[a_{N-1} . . . a₁ a₀], and the second signal 1206 represents a second binary number B=[b_{N-1} . . . b₁ b₀]. Multiplier may be, without limitation, a device such as a communications device, a signal processor, a microprocessor, central processor, and/or computer for operating on data signals.

The multiplier includes a first port 1201 for receiving the first signal 1205. A second port 1202 receives the second signal 1206. Ports 1201 and 1202 may be, without limitation, a serial or parallel interface, as known in the art. Leading zeros may be appended to one of the binary numbers A and B to make the number of bits representing each number A and B equal.

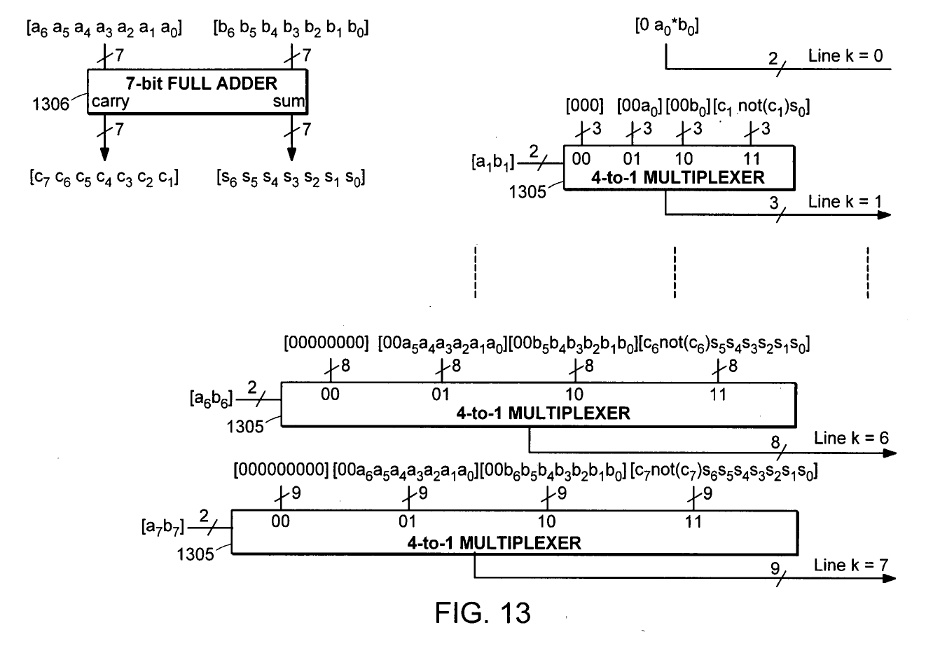

Operatively coupled to the first port 1201 and the second port 1202 is a triangle-array 1003. FIG. 13 is a schematic showing a circuit implementation of the triangle array 1003, in accordance with one embodiment of the invention. The triangle array formed has k=0 to N−1 lines. Line k=0 of the triangle array is equal to [0 (a₀*b₀)], with the multiplication (a₀*b₀) realized using, for example, an AND gate. Each line k=1 to N−1 of the triangle array is formed using a 4-to-1 multiplexer 1305. As described above with regard to FIG. 9, the multiplexers 1305 for each line k=1 to N−1 are controlled by bits aₖ and bₖ. The inputs into each multiplexer 1305 are [0ₖ₊₁ 0ₖ 0ₖ₋₁ . . . 0₀], [0ₖ₊₁ 0ₖ aₖ₋₁ . . . a₁ a₀], [0ₖ₊₁ 0ₖ bₖ₋₁ . . . b₁ b₀], and [cₖ not(cₖ) sₖ₋₁ . . . s₁ s₀]. A (k−1)-bit adder 1306 computes the sum sequence [s_{N-2} . . . s₁ s₀], and the carry-sequence [c_{N-1} . . . c₂ c₁]. The inputs into the adder 1306 are the numbers A and B without their most significant bit's. See FIG. 5 and accompanying text for details regarding the sum and carry sequence.

The resulting elements of the triangle array 1003 may be stored in, without limitation, a register and/or computer readable medium. For example, the triangle-array 1003 may be stored, without limitation, on a diskette, CD-ROM, ROM, RAM, or fixed disk. Prior to storing, the elements of the triangle array 1003 may be positioned, to form, without limitation, a reduced array, as discussed above in connection with FIGS. 10 and 11.

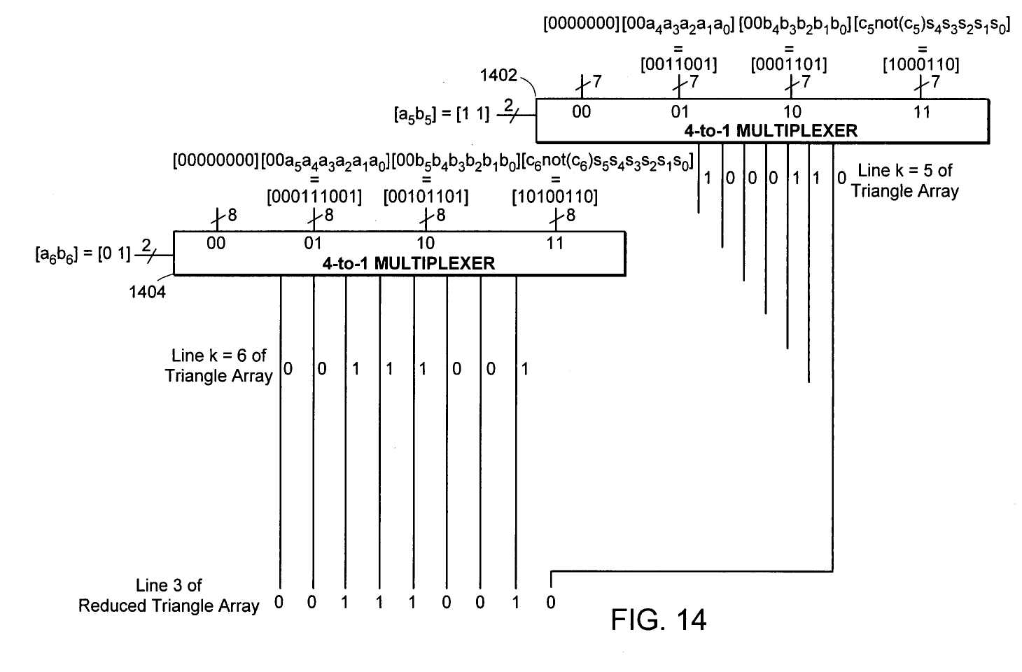

For example, FIG. 14 is a schematic of a circuit implementation that can be used to form the third line 1103 of the reduced array 1101 (with lines 0-4) shown in FIG. 11, in accordance with one embodiment of the invention. Multiplexers 1402 and 1404 form lines k=5 and k=6 of the triangle array 801 shown in FIG. 8. The least significant bit of the output of multiplexer 1402 is appended to the output of multiplexer 1404 to form line 3 (i.e., [0 0 1 1 1 0 0 1 0]) of the reduced array 1101.

Referring back to FIG. 12, an adder 1204 adds the elements of the triangle-array 1003 (which may be positioned to form a reduced array 1208) to produce a third signal 1007. The third signal 1007 represents a product of the first signal 1005 and the second signal 1006.

Squaring of binary numbers represents a special case of the method and system described herein. In a squaring scheme, only symmetrical V's occur, that is, they are composed of either 2 branches of zeros, or 2 branches each containing a truncated version of the number to be squared. The adder to compute the sum-sequence [s_{N-2} . . . s₁ s₀] and the carry-sequence [c_{N-1} . . . c₂ c₁] can be omitted, since the addition of two equal numbers can trivially be achieved by shifting the number to the left and adding a trailing zero. Additionally, the 4-to-1 multiplexers can be replaced by simple AND-gates.

In various embodiments of the invention, the disclosed system and method for multiplying binary numbers may be implemented as a computer program product for use with a computer system or processor. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adaptor connected to a network over a medium. The medium may be either a tangible (e.g., optical or analog communications lines) or a medium implemented with wireless techniques (e.g., microwave, infrared, or other transmission techniques). The series of computer instructions embodies all or part of the functionality previously described herein with respect to the system and method. Those skilled in the art should appreciate that such computer instructions can be written in a number of programming languages for use with may computer architectures or operating systems. Further, such instructions may be stored in any memory device, such as a semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), pre-loaded with a computer system (e.g., on system ROM or fixed disk), or distributed from a server or electronic bulletin board over a network (e.g., the Internet or World Wide Web). Of course, some embodiments of the invention may be implemented as a combination of both software (e.g., a computer program product) and hardware. Still other embodiments of the invention are implemented as entirely hardware, as discussed previously, or entirely software (e.g., a computer program product).

The present invention may be embodied in still other specific forms without departing from the true scope of the invention. The described embodiments are to be considered in all respects only as illustrative and not restrictive.

What is claimed is:

1. A multiplier for multiplying a first signal and a second signal, the first signal representing a first binary number A=[a_{N-1} . . . a₁ a₀], the second signal representing a second binary number B=[b_{N-1} . . . b₁ b₀], the multiplier comprising:
a first port for receiving the first signal;
a second port for receiving the second signal;
a first circuit for generating a triangle array as a function of the first signal and the second signal.

2. The multiplier according to claim 1, wherein the triangle array is stored in a memory element.

3. The multiplier according to claim 1, further including an adder for adding elements of the triangle array to produce a third signal representing a product of the first signal and the second signal.

4. The multiplier according to claim 3, further including a second circuit for positioning the elements of the triangle array to form a reduced array having a reduced number of lines compared to the triangle array, the second circuit operatively coupled to the adder such that the adder adds the reduced number of lines when adding elements of the triangle array.

5. The multipler according to claim 4, wherein the reduced array has
$$\frac{N}{2} + 1$$
lines for even N, and
$$\frac{N + 1}{2}$$
lines for odd N.

6. The multiplier according to claim 1, wherein the triangle array includes lines k=0 to N−1, such that:
the line k=0 of the triangle array is equal to [0 (a₀*b₀)]; and
the lines k=1 to N−1 of the triangle array are equal to:
[0ₖ₊₁ 0ₖ 0ₖ₋₁ . . . 0] if [aₖ bₖ]=[0 0],
[0ₖ₊₁ 0ₖ aₖ₋₁ . . . a₁ a₀] if [aₖ bₖ]=[0 1],
[0ₖ₊₁ 0ₖ bₖ₋₁ . . . b₁ b₀] if [aₖ bₖ]=[1 0], and
[cₖ not(cₖ) sₖ₋₁ . . . s₁ s₀] if [aₖ bₖ]=[1 1],
wherein S=[s_{N-2} . . . s₁ s₀] is equal to the sum sequence A′+B′, where A′=[a_{N-2} . . . a₁ a₀] and B′=[b_{N-2} . . . b₁ b₀], and C=[c_{N-1} . . . c₁] is equal to the carry sequence associated with the sum sequence S.

7. The multiplier according to claim 6, further comprising a second adder for producing the sum sequence S and the carry sequence C.

8. The multiplier according to claim 6, wherein the first circuit includes at least one multiplexer.

9. The multiplier according to claim 8, wherein each line k=1 to N−1 has an associated multiplexer having as inputs [0ₖ₊₁ 0ₖ 0ₖ₋₁ . . . 0], [0ₖ₊₁ 0ₖ aₖ₋₁ . . . a₁ a₀], [0ₖ₊₁ 0ₖ bₖ₋₁ . . . b₁ b₀], and [cₖ not(cₖ) sₖ₋₁ . . . s₁ s₀], the multiplexer controlled by [aₖ bₖ].

10. The multiplier according to claim 1, wherein the triangle array is represented by a number of digits that is substantially 30% less than the number of digits required in a diamond array.

11. The multiplier according to claim 1, wherein the triangle array is represented by a number of digits that is substantially 50% less than the number of digits required in a diamond array.

12. The multiplier according to claim 1, wherein the triangle array includes N(N+3)/2 digits.

13. A processor for multiplying a first signal and a second signal, the first signal representing a first binary number A=[a_{N-1} . . . a₁ a₀], the second signal representing a second binary number B=[b_{N-1} . . . b₁ b₀], the processor comprising:
a first port for receiving the first signal a second port for receiving the second signal;
means for forming a triangle array as a function of the first signal and the second signal.

14. The processor according to claim 13, wherein the means for forming a triangle array includes a memory element for storing the triangle array.

15. The processor according to claim 13, further including an adder for adding elements of the triangle array to form a third signal representing a product of the first signal and the second signal.

16. The processor according to claim 15, wherein the means for forming a triangle array includes a positioning circuit for positioning the elements of the triangle array to form a reduced array having a reduced number of lines compared to the triangle array, the positioning circuit operatively coupled to the adder such that the adder adds the reduced number of lines when adding elements of the triangle array.

17. The multipler according to claim 4, wherein the reduced array has
$$\frac{N}{2} + 1$$
lines for even N, and
$$\frac{N + 1}{2}$$
lines for odd N.

18. The processor according to claim 13, wherein the triangle array includes lines k=0 to N−1, such that:
the line k=0 of the triangle array is equal to [0 (a₀*b₀)]; and
the lines k=1 to N−1 of the triangle array are equal to:
[0ₖ₊₁ 0ₖ 0ₖ₋₁ . . . 0] if [aₖ bₖ]=[0 0],
[0ₖ₊₁ 0ₖ aₖ₋₁ . . . a₁ a₀] if [aₖ bₖ]=[0 1],
[0ₖ₊₁ 0ₖ bₖ₋₁ . . . b₁ b₀] if [aₖ bₖ]=[1 0], and
[cₖ not(cₖ) sₖ₋₁ . . . s1 s₀] if [aₖ bₖ]=[1 1],
wherein S=[s_{N-2} . . . s₁ s₀] is equal to the sum sequence A′+B′, where A′=[a_{N-2} . . . a₁ a₀] and B′=[b_{N-2} . . . b₁ b₀], and C=[c_{N-1} . . . c₁] is equal to the carry sequence associated with the sum sequence S.

19. The processor according to claim 18, further comprising a second adder for producing the sum sequence S and the carry sequence C.

20. The processor according to claim 18, wherein the means for forming the triangle array includes at least one multiplexer.

21. The processor according to claim 20, wherein each line k=1 to N−1 has an associated multiplexer having as inputs [0ₖ₊₁ 0ₖ 0ₖ₋₁ . . . 0], [0ₖ₊₁ 0ₖ aₖ₋₁ . . . a₁ a₀], [0ₖ₊₁ 0ₖ bₖ₋₁ . . . b₁ b₀], and [cₖ not(cₖ) sₖ₋₁ . . . s₁ s₀], the multiplexer controlled by [aₖ bₖ].

22. The processor according to claim 18, wherein the triangle array is represented by a number of digits that is substantially 30% less than the number of digits required in a diamond array.

23. The processor according to claim 18, wherein the triangle array is represented by a number of digits that is substantially 50% less than the number of digits required in a diamond array.

24. The processor according to claim 18, wherein the triangle array includes N(N+3)/2 digits.

25. A computer program product for use on a computer system for multiplying a first binary number A=[a_{N-1} . . . a₁ a₀] and a second binary number B=[b_{N-1} . . . b₁ b₀], the computer program product comprising a computer usable medium having computer readable program code thereon, the computer readable program code comprising:
program code for receiving the first binary number;
program code for receiving the second binary number;
program code for forming a triangle array as a function of the first binary number and the second binary number.

26. The computer program product according to claim 25, further including program code for adding elements of the triangle array to produce a third number representing a product of the first binary number and the second binary number.

27. The computer program product according to claim 26, further including program code for positioning the elements of the triangle array to form a reduced array having a reduced number of lines compared to the triangle array, wherein the program code for adding elements of the triangle array adds the reduced number of lines.

28. The computer product according to claim 27, wherein the reduced array has
$$\frac{N}{2} + 1$$
lines for even N, and
$$\frac{N + 1}{2}$$
lines for odd N.

29. The computer program product according to claim 25, wherein the program code for forming the triangle array includes:
program code for producing lines k=0 to N−1 of the triangle array such that:
the line k=0 of the triangle array is equal to [0 (a₀*b₀)]; and
the lines k=1 to N−1 of the triangle array are equal to:
[0ₖ₊₁ 0ₖ 0ₖ₋₁ . . . 0] if [aₖ bₖ]=[0 0],
[0ₖ₊₁ 0ₖ aₖ₋₁ . . . a₁ a₀] if [aₖ bₖ]=[0 1],
[0ₖ₊₁ 0ₖ bₖ₋₁ . . . b₁ b₀] if [aₖ bₖ]=[1 0], and
[cₖ not(cₖ) sₖ₋₁ . . . s₁ s₀] if [aₖ bₖ]=[1 1],
wherein S=[s_{N-2} . . . s₁ s₀] is equal to the sum sequence A′+B′, where A′=[a_{N-2} . . . a₁ a₀] and B′=[b_{N-2} . . . b₁ b₀], and C=[c_{N-1} . . . c₁] is equal to the carry sequence associated with the sum sequence S.

30. The computer program product according to claim 29, further including program code for producing the sum sequence S and the carry sequence C.

31. The processor according to claim 25, wherein the triangle array is represented by a number of digits that is substantially 30% less than the number of digits required in a diamond array.

32. The processor according to claim 25, wherein the triangle array is represented by a number of digits that is substantially 50% less than the number of digits required in a diamond array.

33. The processor according to claim 25, wherein the triangle array includes N(N+3)/2 digits.

34. A method for performing signal processing that requires multiplication of a first signal representing a binary number A=[a_{N-1} . . . a₁ a₀] and a second signal representing a second binary number B=[b_{N-1} . . . b₁ b₀], the method comprising:
receiving the first signal;
receiving the second signal;
forming a triangle array from the first signal and the second signal.

35. The method according to claim 34, further including adding elements of the triangle array to produce a third signal representing a product of the first signal and the second signal.

36. The method according to claim 35, further including positioning elements of the triangle array to form a reduced array having a reduced number of lines compared to the triangle array, and wherein adding elements of the triangle array include adding the reduced number of lines.

37. The method according to claim 34, wherein forming the triangle array includes:
producing line k=0 of the triangle array such that line k=0 is equal to [0 (a₀*b₀)];
producing lines k=1 to N−1 of the triangle array such that lines k=1 to N−1 are equal to:
[0ₖ₊₁0ₖ 0ₖ₋₁ . . . 0] if [aₖ bₖ]=[0 0],
[0ₖ₊₁ 0ₖ aₖ₋₁ . . . a₁ a₀] if [aₖ bₖ]=[0 1],
[0ₖ₊₁ 0ₖ bₖ₋₁ . . . b₁ b₀] if [aₖ bₖ]=[1 0], and
[cₖ not(cₖ) sₖ₋₁ . . . s₁ s₀] if [aₖ bₖ]=[1 1],
wherein S=[s_{N-2} . . . s₁ s₀] is equal to the sum sequence A′+B′, where A′=[a_{N-2} . . . a₁ a₀] and B′=[b_{N-2} . . . b₁ b₀], and C=[c_{N-1} . . . c₁] is equal to the carry sequence associated with the sum sequence S.
